(19) United States
(12) Patent Application Publication
(10) Pub. No.: US 2025/0218026 A1
(43) Pub. Date: Jul. 3, 2025

(54) INFORMATION PROCESSING APPARATUS, SYSTEM, AND METHOD

(71) Applicant: TOYOTA JIDOSHA KABUSHIKI KAISHA, Toyota-shi Aichi-ken (JP)

(72) Inventors: Toshiki KASHIWAKURA, Ota-ku Tokyo-to (JP); Chihiro INABA, Nerima-ku Tokyo-to (JP); Shoi SUZUKI, Ota-ku Tokyo-to (JP); Tsuyoshi OKADA, Nagoya-shi Aichi-ken (JP); Yasuhiro KOBATAKE, Nagoya-shi Aichi-ken (JP)

(73) Assignee: TOYOTA JIDOSHA KABUSHIKI KAISHA, Toyota-shi Aichi-ken (JP)

(21) Appl. No.: 19/001,987

(22) Filed: Dec. 26, 2024

(30) Foreign Application Priority Data
Dec. 28, 2023 (JP) 2023-223084

(51) Int. Cl. G06T 7/70; H04W 4/44; H04W 64/00; H04W 68/00

(52) U.S. Cl. CPC G06T 7/70; H04W 4/44; H04W 64/006; H04W 68/00; G06T 2207/30252

(57) ABSTRACT

An information processing apparatus includes a controller configured to, when a vehicle approaches a roadside apparatus, which is configured to notify target persons of the presence of vehicles and/or pedestrians, acquire an image of the roadside apparatus captured by an imager provided in the vehicle, acquire vehicle position information indicating a position of the vehicle at the time of capturing the image, acquire, by analyzing the image, relative position information indicating a relative positional relationship between the vehicle and the roadside apparatus at the time of capturing the image, calculate, based on the vehicle position information and the relative position information, calculated position information indicating a calculated position of the roadside apparatus, and transmit the calculated position information to a memory of an information storage apparatus, which is configured to store position information on the roadside apparatus.

### CROSS-REFERENCE TO RELATED APPLICATION

This application claims priority to Japanese Patent Application No. 2023-223084, filed on Dec. 28, 2023, the entire contents of which are incorporated herein by reference.

### TECHNICAL FIELD

The present disclosure relates to an information processing apparatus, a system, and a method.

### BACKGROUND

Technology related to roadside apparatuses that notify target persons, such as pedestrians and drivers or driving assistants of vehicles, of the presence of vehicles or pedestrians is conventionally known. For example, Patent Literature (PTL) 1 discloses a notification system that notifies, according to the behavior of automated driving vehicles scheduled to pass through a predetermined traffic area, vehicles other than the automated driving vehicles, pedestrians, or the like of whether the other vehicles or pedestrians can pass through, warnings, and the like.

### CITATION LIST

### Patent Literature

PTL 1: JP 2023-050629 A

### SUMMARY

When roadside apparatuses incorporate receivers compatible with Global Positioning System (GPS), there may be errors in position information on the roadside apparatuses due to, for example, the accuracy or the like of GPS. These errors may cause, for example, incorrect detection of vehicles approaching the roadside apparatuses.

It would be helpful to improve technology related to roadside apparatuses.

An information processing apparatus according to an embodiment of the present disclosure includes a controller configured to:
when a vehicle approaches a roadside apparatus that is configured to notify target persons of presence of vehicles and/or pedestrians, acquire an image of the roadside apparatus captured by an imager provided in the vehicle;
acquire vehicle position information indicating a position of the vehicle at the time of capturing the image;
acquire, by analyzing the image, relative position information indicating a relative positional relationship between the vehicle and the roadside apparatus at the time of capturing the image;
calculate, based on the vehicle position information and the relative position information, calculated position information indicating a calculated position of the roadside apparatus; and
transmit the calculated position information to a memory of an information storage apparatus that is configured to store position information on the roadside apparatus.

A system according to an embodiment of the present disclosure includes:
the vehicle;
the roadside apparatus; and
the information processing apparatus.

A method according to an embodiment of the present disclosure is a method performed by an information processing apparatus configured to modify position information on a roadside apparatus that is configured to notify target persons of presence of vehicles and/or pedestrians, the method including:
(1) when a vehicle approaches the roadside apparatus, acquiring an image of the roadside apparatus captured by a camera provided in the vehicle;
(2) acquiring vehicle position information indicating a position of the vehicle at the time of capturing the image;
(3) acquiring, by analyzing the image, relative position information indicating a relative positional relationship between the vehicle and the roadside apparatus at the time of capturing the image;
(4) calculating, based on the vehicle position information and the relative position information, calculated position information indicating a calculated position of the roadside apparatus; and
(5) transmitting the calculated position information to a memory of the roadside apparatus or a server apparatus.

According to an embodiment of the present disclosure, technology related to roadside apparatuses is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a vehicle;

FIG. 3 is a block diagram illustrating a schematic configuration of a roadside apparatus;

FIG. 4 is a block diagram illustrating a schematic configuration of an information processing apparatus;

FIG. 5 is a flowchart illustrating operations of the information processing apparatus; and

FIG. 6 is a flowchart illustrating further operations of the information processing apparatus.

### DETAILED DESCRIPTION

Hereinafter, an embodiment of the present disclosure will be described.

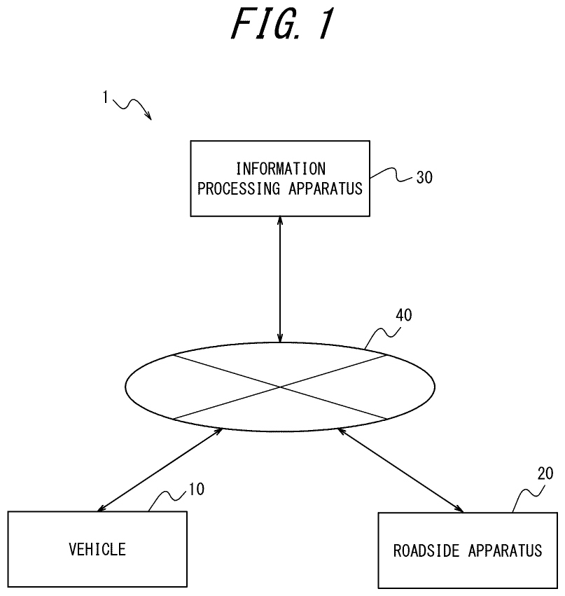

An outline of a system 1 according to the embodiment of the present disclosure will be described with reference to FIG. 1. The system 1 includes one or more vehicles 10, one or more roadside apparatuses 20, and an information processing apparatus 30. The vehicles 10, the roadside apparatuses 20, and the information processing apparatus 30 are communicably connected to a network 40 including, for example, the Internet, a mobile communication network, and the like.

The vehicles 10 are connected cars with communication functions with the network 40. The driving of the vehicles 10 are automated at any level. The automation level may be, for example, any one of Level 1 to Level 5 according to the level classification defined by the Society of Automotive Engineers (SAE). The vehicles 10 may be driven by drivers. The vehicles 10 are, for example, automobiles such as battery electric vehicles (BEVs), hybrid electric vehicles (HEVs), plug-in hybrid electric vehicles (PHEVs), or fuel cell electric vehicle (FCEVs), but may be any vehicles, not limited to these. The number of vehicles 10 provided in the system 1 may be freely determined.

The vehicles 10 are each provided with a camera to image the roadside apparatuses 20. The vehicles 10 may be each provided with the camera and a distance measurement apparatus such as millimeter wave radar or Light Detection and Ranging (LiDAR).

The vehicles 10 each incorporate a GPS-compatible receiver. With the use of GPS and any other satellite positioning system (e.g., the Quasi-Zenith Satellite System), or the use of GPS and high-precision map information, the vehicles 10 can acquire more precise position information (hereinafter referred to as “high-precision position information”) than when using GPS alone.

Upon detecting a pedestrian with a camera installed therein, a roadside apparatus 20 notifies the pedestrian of the presence of a vehicle 10 approaching the roadside apparatus 20. The roadside apparatus 20 may further notify a driver or driving assistant of the vehicle 10 of the presence of the pedestrian. The roadside apparatus 20 notifies the pedestrian of the presence of the automated driving vehicle by, for example, displaying an image on a display installed in the roadside apparatus 20, emitting light from an electronic bulletin board, outputting sound using a speaker, or the like. The roadside apparatus 20 further notifies the driver or driving assistant of the vehicle 10 of the presence of the pedestrian via, for example, a portable terminal of the driver or driving assistant. The roadside apparatuses 20 are installed in the vicinities of the boundary between a road and a sidewalk near crosswalks, intersections, or the like. The roadside apparatuses 20 may be installed in the vicinities of roads with poor visibility, such as blind spots of buildings or curves. The roadside apparatuses 20 may or may not be fixed to the roads or sidewalks. For example, the roadside apparatuses 20 may simply be placed on the roads or sidewalks.

The roadside apparatuses 20 each incorporate a GPS-compatible receiver. The incorporation of the GPS-compatible receiver into the roadside apparatuses 20 allows easy acquisition of position information on the roadside apparatuses 20 at the time of installation. This eliminates the need for a user to manually set the position information on the roadside apparatuses 20. The roadside apparatuses 20 may have autonomous driving functions to move automatically. In such a case, the roadside apparatuses 20 can be installed automatically.

The information processing apparatus 30 calculates, using images of the roadside apparatuses 20 captured by the cameras of the vehicles 10 and the high-precision position information on the vehicles 10, modified position information on the roadside apparatuses 20. When there are position deviations in the position information on the roadside apparatuses 20, the position information on the roadside apparatuses 20 before modification is modified with the calculated position information.

The information processing apparatus 30 according to the present embodiment is a portable terminal. The portable terminal is, for example, a smartphone, a tablet, a laptop computer, or the like.

First, an outline of the present embodiment will be described, and details thereof will be described later. When a vehicle 10 approaches a roadside apparatus 20, which notifies target persons of the presence of vehicles or pedestrians, the information processing apparatus 30 acquires an image of the roadside apparatus 20 captured by a camera provided in the vehicle 10. The information processing apparatus 30 acquires vehicle position information indicating a position of the vehicle 10 at the time of capturing the image. The information processing apparatus 30 acquires, by analyzing the image, relative position information indicating a relative positional relationship between the vehicle 10 and the roadside apparatus 20 at the time of capturing the image. The information processing apparatus 30 calculates, based on the vehicle position information and the relative position information, calculated position information indicating a calculated position of the roadside apparatus 20. The information processing apparatus 30 then transmits the calculated position information to a memory of an information storage apparatus, which stores the position information on the roadside apparatuses 20.

Thus, according to the present embodiment, when a vehicle approaches a roadside apparatus 20, calculated position information on the roadside apparatus 20, which is calculated based on vehicle position information, is transmitted to the information storage apparatus. Thus, the information storage apparatus can determine whether there is an error in stored position information, for example, by comparison between the stored position information on the roadside apparatus 20 and the calculated position information. Therefore, even in locations in which GPS accuracy is low, such as in locations behind buildings or locations between high-rise buildings, accurate position information on the roadside apparatuses 20 can be acquired without dedicated apparatuses, such as receivers for a high-precision satellite positioning system. When the roadside apparatuses 20 are provided with receivers that are compatible with the high-precision satellite positioning system, the cost of the receivers increases as the number of roadside apparatuses 20 installed increases. Therefore, the present embodiment is desirable in terms of cost. When the roadside apparatuses 20 are provided with internal batteries, the use of the high-precision satellite positioning system increases power consumption of the internal batteries. Therefore, the present embodiment is desirable in terms of power consumption of the roadside apparatuses 20.

Furthermore, according to the present embodiment, it is possible to acquire high-precision position information on the roadside apparatuses 20 even when the roadside apparatuses 20 do not have the GPS-compatible receivers. This reduces the effort and cost of installing the GPS-compatible receivers in the roadside apparatuses 20. In locations in which GPS accuracy is expected to be low (e.g., locations in the vicinity of obstacles such as high-rise buildings), the roadside apparatuses 20 without the GPS-compatible receivers may be installed. In locations in which GPS accuracy is expected to be sufficiently high (e.g., locations with few obstacles), the roadside apparatuses 20 with the GPS-compatible receivers may be installed. By predetermining the presence or absence of the GPS-compatible receivers according to installation locations, it is possible to reduce the effort and cost of installing the roadside apparatuses 20.

Therefore, the present embodiment improves technology related to the roadside apparatuses 20.

Next, configurations of the system 1 will be described in detail.

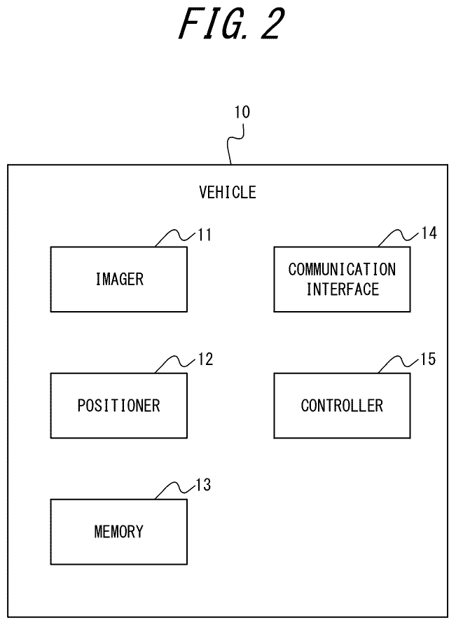

As illustrated in FIG. 2, the vehicle 10 includes an imager 11, a positioner 12, a memory 13, a communication interface 14, and a controller 15.

The imager 11 includes at least one camera that can capture images of subjects. The camera is a forward camera, a side camera, a rear camera, or the like. The imager 11 may include the camera and/or a distance measurement apparatus such as millimeter wave radar or LiDAR. The camera may produce one or more still images or one or more moving images.

The positioner 12 includes receivers compatible with satellite positioning systems. Specifically, the positioner 12 includes a GPS-compatible receiver. The positioner 12 may be able to acquire position information on the vehicle 10 with higher accuracy than when using GPS alone. For example, the positioner 12 may be provided with a receiver compatible with another satellite positioning system, such as Quasi-Zenith Satellite System (QZSS), BeiDou, Global Navigation Satellite System (GLONASS), or Galileo. QZSS satellites are called quasi-zenith satellites. The positioner 12 may use GPS and high-precision map data. In other words, the positioner 12 may acquire rough position information on the vehicle 10 using GPS, and then perform self-position estimation (localization) with reference to the high-precision map data. The high-precision map data is stored, for example, in the memory 13 of the vehicle 10. The positioner 12 may further include a sensor, such as an orientation sensor to measure an orientation of the vehicle 10. The orientation sensor can measure the orientation, for example, by detecting magnetic force of the terrestrial magnetism.

The memory 13 includes one or more memories. The memories included in the memory 13 may each function as, for example, a main memory, an auxiliary memory, or a cache memory. The memory 13 stores any information to be used for operations of the vehicle 10. For example, the memory 13 may store a system program, an application program, a database, position information on the vehicle 10, map information, and the like.

The communication interface 14 includes at least one communication interface for connecting to the network 40. This communication interface is compliant with, for example, a mobile communication standard such as the 4th generation (4G) standard or the 5th generation (5G) standard, but is not limited to these. In the present embodiment, the vehicle 10 communicates with the information processing apparatus 30 via the communication interface 14 and the network 40.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls the operations of the entire vehicle 10.

### (Configuration of Roadside Apparatus 20)

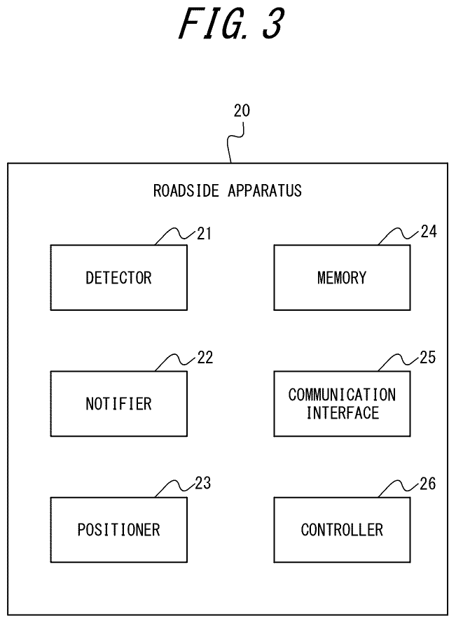

As illustrated in FIG. 3, each roadside apparatus 20 includes a detector 21, a notifier 22, a positioner 23, a memory 24, a communication interface 25, and a controller 26.

The detector 21 includes at least one camera to image pedestrians in the vicinity of the roadside apparatus 20. The camera may be two 180-degree cameras or one 360-degree camera, or any other camera.

The notifier 22 includes at least one notification apparatus that notifies the pedestrians in the vicinity of the roadside apparatus 20 of the presence of vehicles. The notification apparatus is, for example, a display, an electronic bulletin board, or a speaker. The notifier 22 may include any other notification apparatuses.

The positioner 23 includes a GPS-compatible receiver. Map data used by the positioner 23 is stored, for example, in the memory 24 of the roadside apparatus 20.

The memory 24 includes one or more memories. The memories included in the memory 24 may each function as, for example, a main memory, an auxiliary memory, or a cache memory. The memory 24 stores any information to be used for operations of the roadside apparatus 20. For example, the memory 24 may store a system program, an application program, embedded software, map information, and the like. The information stored in the memory 24 may be updated with, for example, information acquired from the network 40 via the communication interface 25.

The communication interface 25 includes at least one communication interface for connecting to the network 40. This communication interface is compliant with, for example, a mobile communication standard such as the 4th generation (4G) standard or the 5th generation (5G) standard, but is not limited to these. In the present embodiment, the roadside apparatus 20 communicates with the information processing apparatus 30 via the communication interface 25 and the network 40.

The controller 26 includes at least one processor, at least one programmable circuit, at least one dedicated circuit, or a combination of these. The controller 26 controls operations of the entire roadside apparatus 20.

### (Configuration of Information Processing Apparatus 30)

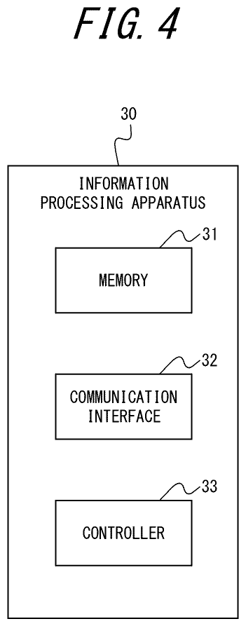

As illustrated in FIG. 4, the information processing apparatus 30 includes a memory 31, a communication interface 32, and a controller 33.

The memory 31 includes one or more memories. The memories included in the memory 31 may each function as, for example, a main memory, an auxiliary memory, or a cache memory. The memory 31 stores any information to be used for operations of the information processing apparatus 30. For example, the memory 31 may store a system program, an application program, embedded software, and the like.

The communication interface 32 includes at least one communication interface for connecting to the network 40. This communication interface is compliant with, for example, a mobile communication standard such as the 4th generation (4G) standard or the 5th generation (5G) standard, but is not limited to these. In the present embodiment, the information processing apparatus 30 communicates with the vehicles 10 and the roadside apparatuses 20 via the communication interface 32 and the network 40.

The controller 33 includes at least one processor, at least one programmable circuit, at least one dedicated circuit, or a combination of these. The controller 33 controls operations of the entire information processing apparatus 30.

### (Operation Flow of Information Processing Apparatus 30)

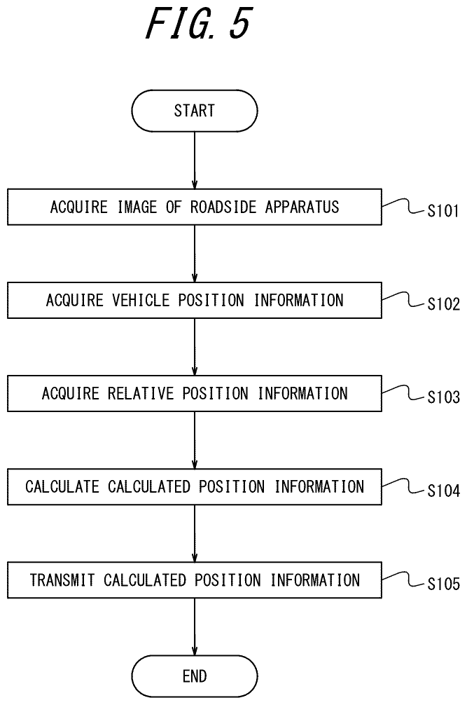

Operations of the information processing apparatus 30 according to the present embodiment will be described with reference to FIG. 5.

S101: When a vehicle 10 approaches a roadside apparatus 20, which notifies target persons of the presence of vehicles and/or pedestrians, the controller 33 of the information processing apparatus 30 acquires an image of the roadside apparatus 20 captured by an imager 11 provided in the vehicle 10.

The roadside apparatus 20 may be imaged when the vehicle 10 is closest to the roadside apparatus 20. The roadside apparatus 20 may be imaged continuously or at regular time intervals during a certain period of time between the approach of the vehicle 10 to the roadside apparatus 20 and moving away therefrom. That is, the image may be one or more still images or one or more moving images. The roadside apparatus 20 may be imaged during installation the roadside apparatus 20, or during actual use of the roadside apparatus 20.

The imager 11 includes at least one camera. The imager 11 may use millimeter wave radar or LiDAR, instead of the camera. The imager 11 may use the millimeter wave radar, LiDAR, and/or the like, together with the camera. The roadside apparatus 20 may be imaged using, for example, another camera (e.g., street camera or surveillance camera). Which camera to use may be determined by, for example, comparison between the accuracy of the camera in the imager 11 and the accuracy of the other camera, or comparison between the accuracy of position information on the vehicle 10 and the accuracy of position information on the other camera. The controller 15 may make this determination.

The controller 33 of the information processing apparatus 30 may receive the image from the imager 11 of the vehicle 10 via the communication interface 32 of the information processing apparatus 30 and the network 40.

Step S102: The controller 33 acquires vehicle position information indicating a position of the vehicle 10 at the time of capturing the image.

The vehicle position information is measured by the positioner 12 of the vehicle 10. The vehicle position information includes a latitude and a longitude of the vehicle 10 at the time of capturing the image. The vehicle position information may also include an orientation of the vehicle 10 at the time of capturing the image. The orientation of the vehicle 10 may be measured, for example, by an orientation sensor provided in the positioner 12.

The controller 33 may receive the vehicle position information from the vehicle 10 via the communication interface 32 and the network 40. When a server apparatus is monitoring the vehicle position information, the controller 33 may receive the vehicle position information from the server apparatus via the communication interface 32 and the network 40.

S103: The controller 33 acquires, by analyzing the image, relative position information indicating a relative positional relationship between the vehicle 10 and the roadside apparatus 20 at the time of capturing the image.

A landmark or other features in the image may be used for analyzing the image. The landmark is, for example, a building, a sign, or a road marking. To acquire more precise relative position information, the controller 33 analyzes the image and data measured by the millimeter wave radar, LiDAR, and/or the like, to acquire the relative position information.

The relative position information may include a distance between the vehicle 10 and the roadside apparatus 20 and a direction of the roadside apparatus 20 viewed from the vehicle 10. The controller 33 may calculate the distance between the vehicle 10 and the roadside apparatus 20 using, for example, any distance measuring algorithm using a camera. The controller 33 may calculate the direction of the roadside apparatus 20 viewed from the vehicle 10 based on, for example, the orientation of the vehicle 10 indicated by the orientation sensor and an orientation of the imager 11 viewed from the vehicle 10. The relative position information may further include an orientation of the roadside apparatus 20 in the image. The orientation of the roadside apparatus 20 in the image may be calculated from a feature, such as a mark on the roadside apparatus 20, for example.

S104: The controller 33 calculates, based on the vehicle position information and the relative position information, calculated position information indicating a calculated position of the roadside apparatus 20.

For example, the calculated position information is calculated by the following expressions:

$$x = X + Lx , y = Y + Ly$$

Here, x is a latitude of the roadside apparatus 20 to be calculated, and y is a longitude of the roadside apparatus 20 to be calculated. X is a latitude of the vehicle 10 at the time of capturing the image, and Y is a longitude of the vehicle 10 at the time of capturing the image. Lx is a distance in a latitudinal direction between the vehicle 10 and the roadside apparatus 20 at the time of capturing the image, and Ly is a distance in a longitudinal direction between the vehicle 10 and the roadside apparatus 20 at the time of capturing the image. The latitude X and the longitude Y of the vehicle 10 are calculated based on the vehicle position information. The distances Lx and Ly between the vehicle 10 and the roadside apparatus 20 are calculated based on the relative position information. These positions and distances may be calculated in meters (m). The calculated position information may be calculated using any other method.

S105: The controller 33 then transmits the calculated position information to a memory of an information storage apparatus, which stores position information on the roadside apparatuses 20.

In the operation flow illustrated in FIG. 5, the controller 33 transmits the calculated position information without determining whether there is a position deviation between position information (registered position information) on the roadside apparatus 20 that is registered in advance in the apparatus that registers the position information on the roadside apparatuses 20 and the calculated position information calculated in S104. In other words, the information processing apparatus 30 leaves determination of the position deviation to another apparatus than the information processing apparatus 30.

The controller 33 may transmit the calculated position information via the communication interface 32 of the information processing apparatus 30 and the network 40. The information storage apparatus may be the roadside apparatus 20 or a server apparatus. To reduce power consumption, in some embodiments, the information storage apparatus is an apparatus that executes S104 in which the calculated position information is calculated. The information storage apparatus may be any other apparatus. The calculated position information on the roadside apparatus 20 may be transmitted to any other apparatus for further processing.

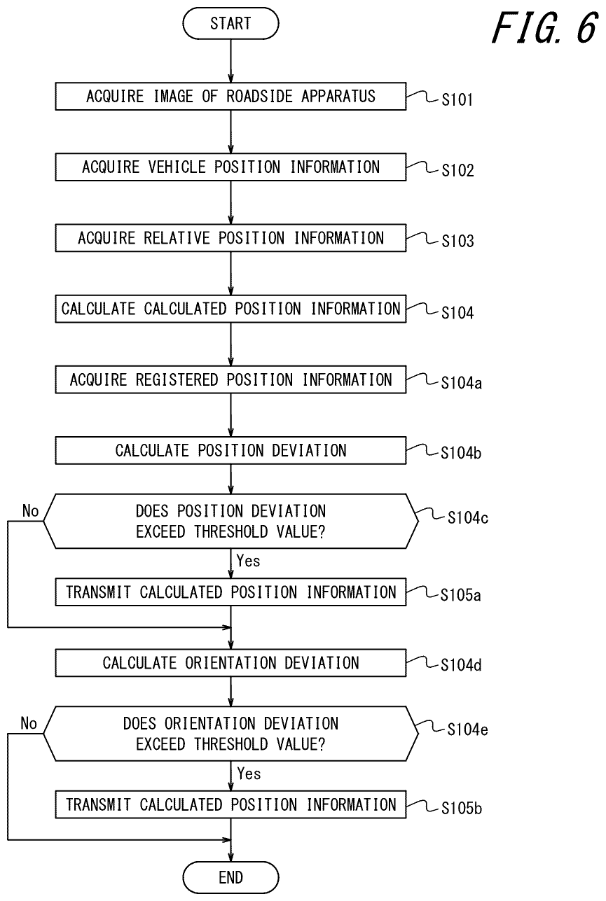

As illustrated in FIG. 6, the information processing apparatus 30 may determine whether there is a position deviation between the registered position of the roadside apparatus 20 and the calculated position thereof. Specifically, S104 may include the following S104a to S104c.

S104a: The controller 33 acquires, from the information storage apparatus, registered position information on the roadside apparatus 20.

The controller 33 may receive the registered position information on the roadside apparatus 20 via the communication interface 32 or the network 40.

S104b: The controller 33 calculates a position deviation between a position of the roadside apparatus 20 indicated by the registered position information and a position of the roadside apparatus 20 indicated by the calculated position information.

For example, the position deviation is calculated by the following expressions:

$$Δ = ( a \hat{} 2 + b \hat{} 2 ) \hat{} ( 1 / 2 ) , a = x - {x}^{′} = ( X + Lx ) - {x}^{′} , \\ b = y - {y}^{′} = ( Y + Ly ) - {y}^{′}$$

Here, Δ is the position deviation, a is a position deviation in the latitudinal direction, b is a position deviation in the longitudinal direction, x′ is a latitude of the roadside apparatus 20 included in the registered position information, y′ is a longitude of the roadside apparatus 20 included in the registered position information, x is a calculated latitude of the roadside apparatus 20, and y is a calculated longitude of the roadside apparatus 20. X is a latitude of the vehicle 10 at the time of capturing the image, and Y is a longitude of the vehicle 10 at the time of capturing the image. Lx is a distance in the latitudinal direction between the vehicle 10 and the roadside apparatus 20 at the time of capturing the image, and Ly is a distance in the longitudinal direction between the vehicle 10 and the roadside apparatus 20 at the time of capturing the image. These positions and distances may be calculated in meters (m). The position deviation may be calculated using any other method.

S104c: The controller 33 determines whether the position deviation exceeds a threshold value.

The threshold value for the position deviation may be set based on the distance resolution of the imager 11 provided in the vehicle 10. The threshold value may be set based on the distance resolution of the camera, millimeter wave radar, or LiDAR. The threshold value may be a value of, for example, 20 m or less, 10 m or less, 5 m or less, 1 m or less, 0.1 m or less, or 0.01 m or less. The threshold value may be set based on any other features.

When S104 includes S104a to S104c, S105 may include the following S105a.

S105a: The controller 33 transmits the calculated position information to the memory of the information storage apparatus when the position deviation exceeds the threshold value for the position deviation.

In other words, the controller 33 may determine whether to transmit the calculated position information, after determining whether the position deviation exceeds the threshold value. When the position deviation does not exceed the threshold value, the controller 33 may not transmit the calculated position information.

When cameras provided in roadside apparatuses cannot capture all directions, i.e., when the viewing angle of the cameras is less than 360 degrees, 180 degrees, 90 degrees, or the like, orientations that the roadside apparatuses face on a map can also be registered for reliable detection of pedestrians or vehicles. For example, the information storage apparatus may store registered orientations of the roadside apparatuses registered in advance. In this case, there may be a deviation between a registered orientation and an actual orientation. Therefore, the calculated position information may include a calculated orientation of the roadside apparatus 20, which is calculated based on the vehicle position information and the relative position information. Specifically, the calculated orientation may be calculated based on the orientation of the vehicle 10 at the time of capturing the image, which is included in the vehicle position information, and the direction of the roadside apparatus 20 viewed from the vehicle 10 at the time of capturing the image and the orientation of the roadside apparatus 20 in the image, which are included in the relative position information. The orientation of the roadside apparatus 20 can be thereby modified.

As illustrated in FIG. 6, the information processing apparatus 30 may determine whether there is an orientation deviation between a registered orientation of the roadside apparatus 20 and the calculated orientation thereof. Specifically, S104 may further include the following S104d to S104e.

S104d: The controller 33 calculates an orientation deviation between the registered orientation of the roadside apparatus 20 and the calculated orientation thereof.

The orientation deviation may be calculated using any method.

S104e: The controller 33 determines whether the orientation deviation exceeds a threshold value.

The threshold value for the orientation deviation may be set based on the size of the field of view and the angular resolution of the camera provided in the vehicle 10. The threshold value for the orientation deviation may be a value of, for example, 10 degrees or less, 1 degree or less, 0.1 degrees or less, or 0.01 degrees or less. The threshold value for the orientation deviation may be set based on any other features.

When S104 includes S104d to S104e, S105 may further include the following S105b.

S105b: The controller 33 transmits the calculated position information to the memory of the information storage apparatus when the orientation deviation exceeds the threshold value for the orientation deviation.

In other words, the controller 33 may determine whether to transmit the calculated position information, after determining whether the orientation deviation exceeds the threshold value. When the orientation deviation does not exceed the threshold value, the controller 33 may not transmit the calculated position information.

S101 to S105 may be repeated until the position deviation and/or the orientation deviation of the roadside apparatus 20 are/is equal to or less than the threshold values/value. S101 to S105 may be repeated three or more times, for example. When the position deviation and/or the orientation deviation of the roadside apparatus 20 are/is equal to or less than the threshold values/value, the position information on the roadside apparatus 20 may be fixed. Whenever S101 to S105 are repeated, the accuracy of the position information on the roadside apparatus 20 can be improved. S101 to S105 may be performed repeatedly by the single information processing apparatus 30, or by multiple information processing apparatuses 30 once per information processing apparatus 30. S101 to S105 may be performed during installation of the roadside apparatus 20, or during provision of notification using the roadside apparatus 20 (e.g., when a pedestrian is in the vicinity of the roadside apparatus 20). S101 to S105 may be performed when communication between the information processing apparatus 30 and the roadside apparatus 20 or between the information processing apparatus 30 and the vehicle 10 is not busy, i.e., when communication speed is equal to or more than a certain level. For safety reasons, the roadside apparatus 20 may suspend providing notification to pedestrians or the like, until the position deviation and/or the orientation deviation of the roadside apparatus 20 are/is equal to or less than the threshold values/value.

As described above, according to the present embodiment, it is possible to provide more accurate position information even when errors occur in position information on the roadside apparatuses 20 indicated by GPS. Therefore, even in locations in which GPS accuracy is low, such as in locations behind buildings or locations between high-rise buildings, accurate position information on the roadside apparatuses 20 can be acquired without dedicated apparatuses, such as receivers for a high-precision satellite system. When the roadside apparatuses 20 are provided with receivers that are compatible with the high-precision satellite positioning system, the cost of the receivers increases as the number of roadside apparatuses 20 installed increases. Therefore, the present embodiment is desirable in terms of cost. When the roadside apparatuses 20 are provided with internal batteries, the use of the high-precision satellite positioning system increases power consumption of the internal batteries. Therefore, the present embodiment is desirable in terms of power consumption of the roadside apparatuses 20.

Furthermore, according to the present embodiment, it is possible to acquire high-precision position information on the roadside apparatuses 20 even when the roadside apparatuses 20 do not have the GPS-compatible receivers. This reduces the effort and cost of installing the GPS-compatible receivers in the roadside apparatuses 20. In locations in which GPS accuracy is expected to be low (e.g., locations in the vicinity of obstacles such as high-rise buildings), the roadside apparatuses 20 without the GPS-compatible receivers may be installed. In locations in which GPS accuracy is expected to be sufficiently high (e.g., locations with few obstacles), the roadside apparatuses 20 with the GPS-compatible receivers may be installed. By predetermining the presence or absence of the GPS-compatible receivers according to installation locations, it is possible to reduce the effort and cost of installing the roadside apparatuses 20.

Thus, the present embodiment improves technology related to roadside apparatuses.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each process, or the like can be rearranged without logical inconsistency, and a plurality of components, processes, or the like can be combined into one or a single component, process, or the like can be divided.

In the present embodiment, the information processing apparatus 30 is a portable terminal. The information processing apparatus 30 may use another server apparatus than the information processing apparatus 30, and the server apparatus may monitor position information on the vehicles 10 indicated by GPS. In another embodiment, the information processing apparatus 30 may be a server apparatus. In yet another embodiment, the information processing apparatus 30 may be the vehicle 10 or the roadside apparatus 20. In other words, the memory 31, the communication interface 32, and the control 33 of the information processing apparatus 30 are common to the memory, the communication interface, and the controller of the vehicle 10 or the roadside apparatus 20, respectively.

For example, an embodiment in which the configuration and operations of the information processing apparatus 30 in the above embodiment are distributed to multiple computers capable of communicating with each other can be implemented. For example, the controller 15 of the vehicle 10 may perform S103 to obtain the relative position information by image analysis, and the controller 33 of the information processing apparatus 30 may perform S104 to calculate the calculated position information.

For example, an embodiment in which a general purpose computer functions as the information processing apparatus 30 according to the above embodiment can also be implemented. Specifically, a program in which processes for realizing the functions of the information processing apparatus 30 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.

[Appendix 1] An information processing apparatus comprising a controller configured to:
when a vehicle approaches a roadside apparatus that is configured to notify target persons of presence of vehicles and/or pedestrians, acquire an image of the roadside apparatus captured by an imager provided in the vehicle; acquire vehicle position information indicating a position of the vehicle at a time of capturing the image;
acquire, by analyzing the image, relative position information indicating a relative positional relationship between the vehicle and the roadside apparatus at the time of capturing the image;
calculate, based on the vehicle position information and the relative position information, calculated position information indicating a calculated position of the roadside apparatus; and
transmit the calculated position information to a memory of an information storage apparatus that is configured to store position information on the roadside apparatus.
   [Appendix 2] The information processing apparatus according to appendix 1, wherein
the vehicle position information includes a latitude and a longitude of the vehicle at the time of capturing the image, and
the relative position information includes a distance between the vehicle and the roadside apparatus at the time of capturing the image and a direction of the roadside apparatus viewed from the vehicle at the time of capturing the image.
   [Appendix 3] The information processing apparatus according to appendix 1 or 2, wherein
the controller is configured to:
   acquire, from the information storage apparatus, registered position information on the roadside apparatus;
   calculate a position deviation between a position of the roadside apparatus indicated by the registered position information and a position of the roadside apparatus indicated by the calculated position information; and
   determine whether the position deviation exceeds a threshold value, and
the transmission of the calculated position information includes transmitting the calculated position information to the memory of the information storage apparatus when the position deviation exceeds the threshold value for the position deviation.
   [Appendix 4] The information processing apparatus according to appendix 3, wherein the threshold value for the position deviation is set based on a distance resolution of a camera provided in the vehicle.
   [Appendix 5] The information processing apparatus according to any one of appendices 1 to 4, wherein
the vehicle position information includes an orientation of the vehicle at the time of capturing the image,
the relative position information includes a direction of the roadside apparatus viewed from the vehicle at the time of capturing the image and an orientation of the roadside apparatus in the image, and
the calculated position information includes a calculated orientation of the roadside apparatus calculated based on the vehicle position information and the relative position information.
   [Appendix 6] The information processing apparatus according to appendix 5, wherein
the information storage apparatus is configured to store a registered orientation of the roadside apparatus registered in advance,
the controller is further configured to:
   calculate an orientation deviation between the registered orientation and the calculated orientation; and
   determine whether the orientation deviation exceeds a threshold value, and
the transmission of the calculated position information includes transmitting the calculated position information to the memory of the information storage apparatus when the orientation deviation exceeds the threshold value for the orientation deviation.
   [Appendix 7] The information processing apparatus according to any one of appendices 1 to 6, wherein the information storage apparatus is the roadside apparatus or a server apparatus.
   [Appendix 8] A system comprising:
an information processing apparatus; and
a roadside apparatus configured to notify target persons of presence of vehicles and/or pedestrians,
wherein
the information processing apparatus and the roadside apparatus are configured to communicate with each other,
the information processing apparatus is configured to:
   when a vehicle approaches the roadside apparatus, acquire an image of the roadside apparatus captured by an imager provided in the vehicle;
   acquire vehicle position information indicating a position of the vehicle at a time of capturing the image;
   acquire, by analyzing the image, relative position information indicating a relative positional relationship between the vehicle and the roadside apparatus at the time of capturing the image;
   calculate, based on the vehicle position information and the relative position information, calculated position information indicating a calculated position of the roadside apparatus; and
   transmit the calculated position information to a memory of an information storage apparatus that is configured to store position information on the roadside apparatus.
      [Appendix 9] The system according to appendix 8, wherein
the vehicle position information includes a latitude and a longitude of the vehicle at the time of capturing the image, and
the relative position information includes a distance between the vehicle and the roadside apparatus at the time of capturing the image and a direction of the roadside apparatus viewed from the vehicle at the time of capturing the image.
   [Appendix 10] The system according to appendix 8 or 9, wherein
the information processing apparatus is configured to:
   acquire, from the information storage apparatus, registered position information on the roadside apparatus;
   calculate a position deviation between a position of the roadside apparatus indicated by the registered position information and a position of the roadside apparatus indicated by the calculated position information;
   determine whether the position deviation exceeds a threshold value, and
the transmission of the calculated position information includes transmitting the calculated position information to the memory of the information storage apparatus when the position deviation exceeds the threshold value for the position deviation.
   [Appendix 11] The system according to appendix 10, wherein the threshold value for the position deviation is set based on a distance resolution of a camera provided in the vehicle.
   [Appendix 12] The system according to any one of appendices 8 to 11, wherein
the vehicle position information includes an orientation of the vehicle at the time of capturing the image,
the relative position information includes a direction of the roadside apparatus viewed from the vehicle at the time of capturing the image and an orientation of the roadside apparatus in the image, and
the calculated position information includes a calculated orientation of the roadside apparatus calculated based on the vehicle position information and the relative position information.
   [Appendix 13] The system according to appendix 12, wherein
the information storage apparatus is configured to store a registered orientation of the roadside apparatus registered in advance,
the information processing apparatus is further configured to:
   calculate an orientation deviation between the registered orientation and the calculated orientation; and
   determine whether the orientation deviation exceeds a threshold value, and
the transmission of the calculated position information includes transmitting the calculated position information to the memory of the information storage apparatus when the orientation deviation exceeds the threshold value for the orientation deviation.
   [Appendix 14] The system according to any one of appendices 8 to 13, wherein the information storage apparatus is the roadside apparatus or a server apparatus.
   [Appendix 15] A method performed by an information processing apparatus configured to modify position information on a roadside apparatus that is configured to notify target persons of presence of vehicles and/or pedestrians, the method comprising:
(1) when a vehicle approaches the roadside apparatus, acquiring an image of the roadside apparatus captured by a camera provided in the vehicle;
(2) acquiring vehicle position information indicating a position of the vehicle at a time of capturing the image;
(3) acquiring, by analyzing the image, relative position information indicating a relative positional relationship between the vehicle and the roadside apparatus at the time of capturing the image;
(4) calculating, based on the vehicle position information and the relative position information, calculated position information indicating a calculated position of the roadside apparatus; and
(5) transmitting the calculated position information to a memory of an information storage apparatus that is configured to store position information on the roadside apparatus.
   [Appendix 16] The method according to appendix 15, wherein
the vehicle position information includes a latitude and a longitude of the vehicle at the time of capturing the image, and
the relative position information includes a distance between the vehicle and the roadside apparatus at the time of capturing the image and a direction of the roadside apparatus viewed from the vehicle at the time of capturing the image.
   [Appendix 17] The method according to appendix 15 or 16, wherein
the calculating includes:
   (4a) acquiring, from the information storage apparatus, registered position information on the roadside apparatus;
   (4b) calculating a position deviation between a position of the roadside apparatus indicated by the registered position information and a position of the roadside apparatus indicated by the calculated position information; and
   (4c) determining whether the position deviation exceeds a threshold value, and
the transmitting includes (5a) transmitting the calculated position information to the memory of the information storage apparatus when the position deviation exceeds the threshold value for the position deviation.
   [Appendix 18] The method according to appendix 17, wherein the threshold value for the position deviation is set based on a distance resolution of the camera provided in the vehicle.
   [Appendix 19] The method according to any one of appendices 15 to 18, wherein
the vehicle position information includes an orientation of the vehicle at the time of capturing the image,
the relative position information includes a direction of the roadside apparatus viewed from the vehicle at the time of capturing the image and an orientation of the roadside apparatus in the image, and
the calculated position information includes a calculated orientation of the roadside apparatus calculated based on the vehicle position information and the relative position information.
   [Appendix 20] The method according to appendix 19, wherein
the information storage apparatus is configured to store a registered orientation of the roadside apparatus registered in advance,
the calculating further includes:
   (4d) calculating an orientation deviation between the registered orientation and the calculated orientation; and
   (4e) determining whether the orientation deviation exceeds a threshold value, and
the transmitting includes (5b) transmitting the calculated position information to the memory of the information storage apparatus when the orientation deviation exceeds the threshold value for the orientation deviation.

1. An information processing apparatus comprising a controller configured to:
when a vehicle approaches a roadside apparatus that is configured to notify target persons of presence of vehicles and/or pedestrians, acquire an image of the roadside apparatus captured by an imager provided in the vehicle;
acquire vehicle position information indicating a position of the vehicle at a time of capturing the image;
acquire, by analyzing the image, relative position information indicating a relative positional relationship between the vehicle and the roadside apparatus at the time of capturing the image;
calculate, based on the vehicle position information and the relative position information, calculated position information indicating a calculated position of the roadside apparatus; and
transmit the calculated position information to a memory of an information storage apparatus that is configured to store position information on the roadside apparatus.

2. The information processing apparatus according to claim 1, wherein
the vehicle position information includes a latitude and a longitude of the vehicle at the time of capturing the image, and
the relative position information includes a distance between the vehicle and the roadside apparatus at the time of capturing the image and a direction of the roadside apparatus viewed from the vehicle at the time of capturing the image.

3. The information processing apparatus according to claim 1, wherein
the controller is configured to:
acquire, from the information storage apparatus, registered position information on the roadside apparatus;
calculate a position deviation between a position of the roadside apparatus indicated by the registered position information and a position of the roadside apparatus indicated by the calculated position information; and
determine whether the position deviation exceeds a threshold value, and
the transmission of the calculated position information includes transmitting the calculated position information to the memory of the information storage apparatus when the position deviation exceeds the threshold value for the position deviation.

4. The information processing apparatus according to claim 3, wherein the threshold value for the position deviation is set based on a distance resolution of a camera provided in the vehicle.

5. The information processing apparatus according to claim 3, wherein
the vehicle position information includes an orientation of the vehicle at the time of capturing the image,
the relative position information includes a direction of the roadside apparatus viewed from the vehicle at the time of capturing the image and an orientation of the roadside apparatus in the image, and
the calculated position information includes a calculated orientation of the roadside apparatus calculated based on the vehicle position information and the relative position information.

6. The information processing apparatus according to claim 5, wherein
the information storage apparatus is configured to store a registered orientation of the roadside apparatus registered in advance,
the controller is further configured to:
calculate an orientation deviation between the registered orientation and the calculated orientation; and
determine whether the orientation deviation exceeds a threshold value, and
the transmission of the calculated position information includes transmitting the calculated position information to the memory of the information storage apparatus when the orientation deviation exceeds the threshold value for the orientation deviation.

7. The information processing apparatus according to claim 1, wherein the information storage apparatus is the roadside apparatus or a server apparatus.

8. A system comprising:
an information processing apparatus; and
a roadside apparatus configured to notify target persons of presence of vehicles and/or pedestrians,
wherein
the information processing apparatus and the roadside apparatus are configured to communicate with each other,
the information processing apparatus is configured to:
when a vehicle approaches the roadside apparatus, acquire an image of the roadside apparatus captured by an imager provided in the vehicle;
acquire vehicle position information indicating a position of the vehicle at a time of capturing the image;
acquire, by analyzing the image, relative position information indicating a relative positional relationship between the vehicle and the roadside apparatus at the time of capturing the image;
calculate, based on the vehicle position information and the relative position information, calculated position information indicating a calculated position of the roadside apparatus; and
transmit the calculated position information to a memory of an information storage apparatus that is configured to store position information on the roadside apparatus.

9. The system according to claim 8, wherein
the vehicle position information includes a latitude and a longitude of the vehicle at the time of capturing the image, and
the relative position information includes a distance between the vehicle and the roadside apparatus at the time of capturing the image and a direction of the roadside apparatus viewed from the vehicle at the time of capturing the image.

10. The system according to claim 8, wherein
the information processing apparatus is configured to:
acquire, from the information storage apparatus, registered position information on the roadside apparatus;
calculate a position deviation between a position of the roadside apparatus indicated by the registered position information and a position of the roadside apparatus indicated by the calculated position information;
determine whether the position deviation exceeds a threshold value, and
the transmission of the calculated position information includes transmitting the calculated position information to the memory of the information storage apparatus when the position deviation exceeds the threshold value for the position deviation.

11. The system according to claim 10, wherein the threshold value for the position deviation is set based on a distance resolution of a camera provided in the vehicle.

12. The system according to claim 10, wherein
the vehicle position information includes an orientation of the vehicle at the time of capturing the image,
the relative position information includes a direction of the roadside apparatus viewed from the vehicle at the time of capturing the image and an orientation of the roadside apparatus in the image, and
the calculated position information includes a calculated orientation of the roadside apparatus calculated based on the vehicle position information and the relative position information.

13. The system according to claim 12, wherein
the information storage apparatus is configured to store a registered orientation of the roadside apparatus registered in advance,
the information processing apparatus is further configured to:
calculate an orientation deviation between the registered orientation and the calculated orientation; and
determine whether the orientation deviation exceeds a threshold value, and
the transmission of the calculated position information includes transmitting the calculated position information to the memory of the information storage apparatus when the orientation deviation exceeds the threshold value for the orientation deviation.

14. The system according to claim 8, wherein the information storage apparatus is the roadside apparatus or a server apparatus.

15. A method performed by an information processing apparatus configured to modify position information on a roadside apparatus that is configured to notify target persons of presence of vehicles and/or pedestrians, the method comprising:
(1) when a vehicle approaches the roadside apparatus, acquiring an image of the roadside apparatus captured by a camera provided in the vehicle;
(2) acquiring vehicle position information indicating a position of the vehicle at a time of capturing the image;
(3) acquiring, by analyzing the image, relative position information indicating a relative positional relationship between the vehicle and the roadside apparatus at the time of capturing the image;
(4) calculating, based on the vehicle position information and the relative position information, calculated position information indicating a calculated position of the roadside apparatus; and
(5) transmitting the calculated position information to a memory of an information storage apparatus that is configured to store position information on the roadside apparatus.

16. The method according to claim 15, wherein
the vehicle position information includes a latitude and a longitude of the vehicle at the time of capturing the image, and
the relative position information includes a distance between the vehicle and the roadside apparatus at the time of capturing the image and a direction of the roadside apparatus viewed from the vehicle at the time of capturing the image.

17. The method according to claim 15, wherein
the calculating includes:
(4a) acquiring, from the information storage apparatus, registered position information on the roadside apparatus;
(4b) calculating a position deviation between a position of the roadside apparatus indicated by the registered position information and a position of the roadside apparatus indicated by the calculated position information; and
(4c) determining whether the position deviation exceeds a threshold value, and
the transmitting includes (5a) transmitting the calculated position information to the memory of the information storage apparatus when the position deviation exceeds the threshold value for the position deviation.

18. The method according to claim 17, wherein the threshold value for the position deviation is set based on a distance resolution of the camera provided in the vehicle.

19. The method according to claim 17, wherein
the vehicle position information includes an orientation of the vehicle at the time of capturing the image,
the relative position information includes a direction of the roadside apparatus viewed from the vehicle at the time of capturing the image and an orientation of the roadside apparatus in the image, and
the calculated position information includes a calculated orientation of the roadside apparatus calculated based on the vehicle position information and the relative position information.

20. The method according to claim 19, wherein
the information storage apparatus is configured to store a registered orientation of the roadside apparatus registered in advance,
the calculating further includes:
(4d) calculating an orientation deviation between the registered orientation and the calculated orientation; and
(4e) determining whether the orientation deviation exceeds a threshold value, and
the transmitting includes (5b) transmitting the calculated position information to the memory of the information storage apparatus when the orientation deviation exceeds the threshold value for the orientation deviation.
